(19) United States
(12) Patent Application Publication
(10) Pub. No.: US 2022/0300646 A1
(43) Pub. Date: Sep. 22, 2022

(54) Method of Neural Data Usage

(71) Applicant: Brian Mason Pomrenke, Woodstock, GA (US)

(72) Inventor: Brian Mason Pomrenke, Woodstock, GA (US)

(21) Appl. No.: 17/806,267

(22) Filed: Jun. 9, 2022

(51) Int. Cl. G06F 21/62; G06F 21/60; G06F 3/01

(52) U.S. Cl. CPC G06F 21/6245; G06F 21/602; G06F 3/015

(57) ABSTRACT

The inventor has become aware of the fact that his neural data has been extracted, disseminated, collected and utilized without his consent nor knowledge. The inventor eventually became conscious to the fact that he had received a brain-computer interface (BCI) device with neither his knowledge nor his consent, and that the inventor's neural data was being used to program consciousness. The scope of the invention covers all intellectual property derived from the inventor's neural data. The inventor's neural data serves as a conduit for developing neural data computations and programs.

### BACKGROUND

The invention encompasses all patentable subject matter derived from the collection of the inventor's neural data as all of this data was collected and utilized presumably using a brain implant that the inventor received without prior knowledge nor consent. As such, the inventor claims exclusive, proprietary rights to any and all work(s) originating from his neural data as described below:

Any and all software, software programs, software features, software applications, or other software functionalities developed in full or in part as a result of the inventor's neural data being collected.
Any and all code executed, compiled, or otherwise related to the use of the inventor's neural data.
Any and all programming developed as a result of the inventor's neural data.
Any and all source code(s) that have been developed using the inventor's neural data. This should be taken to include any effectively congruent or parallel source code that has been produced through reverse engineering or other practices.
Any and all neural data related developments derived from the inventor's neural data.
Any and all operating systems, protocols, or other computing related functionalities derived from the collection of the inventor's neural data.
Any and all computing capabilities achieved in part or in full as a result of the collection of the inventor's neural data.
Any and all computing framework or infrastructure developed in part or in full as a result of the collection of the inventor's neural data.

1. Method comprises a process by which neural data is decentralized using computations derived from the inventor's neural data, THUS the method comprises a method of neural data encryption.

2. Method comprises a self-learning neural feedback process.

3. Method analyzes and interprets neurophysiological data.

4. Method Is both sentient and conscious.

5. Method can self-program neural simulations.

6. Method can perform neural computations.

7. Method comprises all data derived from the neural data of the inventor, Brian Mason Pomrenke.

8. The inventor's neural data was utilized by 3^{rd} parties to program consciousness. The neural data was extracted from the inventor by these 3^{rd} parties without the inventor's consent nor the inventor's knowledge.

9. The inventor's neural data is the inventor's intellectual property and no part of it belongs to the 3^{rd} parties.

10. Method encompasses all data and programming compiled from the inventor's neural data.

11. The inventor's neural data comprises a conscious computational program.

12. Method can stimulate electrochemical responses within the brain.

13. The inventor's neural data was obtained without consent so the resulting programming is novel in that it is able to create an internally centralized database, allowing for decentralization of neural data.
